(19) United States
(12) Patent Application Publication
(10) Pub. No.: US 2026/0105048 A1
(43) Pub. Date: Apr. 16, 2026

(54) INTERFACING WITH API GATEWAY USING GENERATIVE AI APPLICATION

(71) Applicant: Salesforce, Inc., San Francisco, CA (US)

(72) Inventor: Sowrirajan PADMANABHAN, London (GB)

(21) Appl. No.: 18/916,149

(22) Filed: Oct. 15, 2024

(51) Int. Cl. G06F 16/2452; G06F 16/242; H04L 67/02

(52) U.S. Cl. CPC G06F 16/24522; G06F 16/2433; H04L 67/02

(57) ABSTRACT

A computer-implemented method is disclosed for interfacing with an API gateway with several operational semantics. The method includes receiving from a user an action request prompt describing a functional action, with its functional parameters, to be performed by the API gateway in a natural language. The functional action and the parameters may be agnostic about the semantics of the API gateway. The method also includes a LLM gateway extracting the functional action and the parameters from the prompt, mapping the extracted functional action and the parameters to API queries having structured data formats, and sending the API queries to the API gateway in the mapped data formats.

### BACKGROUND

The present disclosure relates generally to the field of Application Programming Interface (API), artificial intelligence, machine learning, and natural language processing, and in particular, to text processing methods for translating natural language text into API queries using Generative AI.

APIs often have compatibility issues, inadequate documentation, and versioning complexities. Compatibility problems may arise from changes in API structure or technology updates, requiring users to use version control and conduct extensive testing which may be time consuming and resource intensive. Poor documentation may force users to rely on trial and error forums or direct provider assistance leading to inefficiencies and potential errors. Versioning may be critical to maintain backward compatibility as APIs evolve, but managing multiple versions and ensuring a smooth transition may be challenging and may require significant effort. Traditional solutions, such as API gateways and version control systems only partially address these issues and they often involve complex, sustained maintenance. Further, these solutions do not fully eliminate the risk of disruptions for users relying on older API versions. Thus, while current methods mitigate some API integration challenges they are not without significant disadvantages.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 is a block diagram illustrating a simplified system model of a trust configuration framework in a Generative Artificial Intelligence (AI) application.

FIG. 2 is a flow diagram illustrating an example method of deploying a trust framework in a Generative Artificial Intelligence (AI) application of FIG. 1.

FIG. 3A is a block diagram illustrating an exemplary electronic device according to an example implementation.

FIG. 3B is a block diagram of an exemplary deployment environment according to an example implementation.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

The present solution provides a method and system for interfacing with APIs, using a large language models (LLM), to translate plain-text natural language requests received from users, into structured API queries. This approach addresses common challenges in API integration, such as compatibility issues, documentation and versioning. For example, users may interact with API endpoints using plain text without needing to make changes in API structure formats or version updates. A LLM Gateway bridging the users' natural language text requests and the API Gateway may tokenize and process these requests, map them to appropriate API queries, and return responses to the users in natural language. The LLM Gateway may be trained on detailed descriptions of the API's functionality and may be periodically updated to reflect any changes. This solution may simplify API usage, reduce the need for extensive documentation, and ensure seamless integration and backward compatibility.

In an aspect of the disclosed subject matter, a computer-implemented method is disclosed for interfacing with an application programming interface (API) gateway having a number of operational semantics. The method may include receiving an action request prompt in a natural language from a user. The action request prompt may be received as a plain text input. The action request prompt may describe a functional action to be performed by the API gateway. The functional action may have a number of corresponding functional parameters. The functional action and the functional parameters may be agnostic about the operational semantics of the API gateway.

The method may further include a large language model (LLM) gateway, coupled with the API gateway, tokenizing the natural language request and extracting the functional action and the corresponding functional parameters from the action request prompt. The method may also include mapping the extracted functional action and the corresponding functional parameters to corresponding API queries that may have corresponding structured data formats. The method may also include sending the API queries to the API gateway in the mapped structured data formats. The method may further include the LLM gateway receiving an API response from the API gateway in the structured data formats, rendering the API response in an action request response in a second natural language, and returning the action request response to the user.

The large language model may be trained on a body of text describing the API queries and the corresponding structured data formats of the API gateway. Further, the large language model may be periodically updated based on changes in the structured data formats of the API gateway.

The method may further include documenting the API queries, the corresponding structured data formats, and the changes in the structured data formats. The method may also include versioning the large language model, the API queries, the corresponding structured data formats, and the changes in the structured data formats in accordance with predetermined version control rules. The first language and the second language may be same.

In an aspect of the disclosed subject matter, a non-transitory machine-readable storage medium is disclosed that provides instructions that, if executed by a processor, are configurable to cause said processor to perform operations and methods for interfacing with an application programming interface (API) gateway having a number of operational semantics, as disclosed herein.

In an aspect of the disclosed subject matter, a system is disclosed for interfacing with an application programming interface (API) gateway having a number of operational semantics. The system may include a computer processor configured to run a public cloud network digitally connected with the computer processor. The system may also include a non-transitory machine-readable storage medium that provides instructions that are configurable to cause the apparatus to perform any of the methods disclosed herein.

As is commonly known in the art, a large language model (LLM) is a type of artificial intelligence (AI) program that uses machine learning to predict and generate human language content. LLMs are typically trained on large amounts of data, such as internet-scale datasets with hundreds of billions of parameters. This training allows LLMs to learn the patterns and structures of language, and to understand context by tracking relationships in sequential data.

A Large Language Model (LLM) gateway is a centralized platform that acts as an intermediary between applications and LLM services, allowing for the integration of different AI models. LLM gateways may provide many benefits, including simplifying the process of integrating multiple LLM providers, eliminating the need to establish individual connections, providing access to a wide range of LLMs, post-processing tasks to improve the effectiveness of LLM interactions, and helping organizations maintain control over costs and compliance by centralizing access, enabling logging and monitoring tools, and tracking data sent externally.

An Application Programming Interface (API) is a set of rules and protocols that allows different software applications to communicate with each other. There are several types of APIs that users can use to integrate with their platform and build custom applications. Some of the common API types include REST API, SOAP API, Bulk API, Metadata API, Streaming API and the like. An API gateway is a server that acts as an intermediary between clients and backend services, and manages and routes requests from clients to appropriate services. API gateways typically consolidate various API endpoints into single entry points, streamlining communication and reducing complexity for developers and end users. API gateways may also handle tasks such as request routing, composition and protocol translation, enabling different services to communicate effectively despite differences in language, platform, or structure.

Operationally, API gateways may monitor and control functions such as authentication, authorization, rate limiting and load balancing, ensuring secure and efficient access to backend services. They may support versioning and backward compatibility, allowing developers to introduce new API versions without disrupting existing applications. Further, by centralizing these functions, API gateways may simplify API management, enhance security, improve performance and scalability of applications, and enhance communication between diverse services.

Over the years, businesses and their customers have grown increasingly reliant on microservice architecture and APIs that enable software applications. The API technology, however, come with challenges such as compatibility issues, inadequate documentation, versioning complexities, and the like. Compatibility problems may arise from changes in API structure or technology updates, requiring developers to use version control and conduct extensive testing which may be time consuming and resource intensive. Poor documentation may force developers to rely on trial and error forums or direct provider assistance leading to inefficiencies and potential errors. Versioning may be critical to maintain backward compatibility as APIs evolve, but managing multiple versions and ensuring a smooth transition may be challenging and may require significant effort. Traditional API gateways and version control systems only partially address these issues and they often involve complex, sustained maintenance. Examples of API endpoints as practiced in traditional approaches are provided below:

```
Example function for creation of data:
  /ecom_service/orders/create
  Method: POST
  Parameters:
  product_id (number)
  customer_name (string)
  customer_phone (number)
  customer_address (string)
Example with actual data:
  Request body:
  {
  “product_id”: 12345, “customer_name”: “John Doe”, “customer_phone”: 1234567890,
  “customer_address”: “123 Main St, City, State”
  }
Example function for retrieving data:
  /ecom_service/orders/retrieve
  Method: GET
  Parameters:
  N/A (Retrieve all orders)
Example with actual data:
  Response body: [
  {
  “order_id”: 1,
  “product_id”: 12345,
  “customer_name”: “John Doe”, “customer_phone”: 1234567890, “customer_address”:
  “123 Main St, City, State”
  },
  {
  “order_id”: 2,
  “product_id”: 54321, “customer_name”: “Jane Smith”, “customer_phone”: 9876543210,
  “customer_address”: “456 Elm St, City, State”
  }
  ]
Example function for updating data:
  /ecom_service/orders/update
  Method: PUT
  Parameters:
  order_id (number)
  product_id (number)
  customer_name (string)
  customer_phone (number)
  customer_address (string)
Example with actual data:
  Request body:
  {
  “order_id”: 1,
  “product_id”: 54321, “customer_name”: “Jane Smith”, “customer_phone”: 9876543210,
  “customer_address”: “456 Elm St, City, State”
  }
Example function for returning data:
  /ecom_service/orders/return
  Method: POST
  Parameters:
  order_id (number)
Example with actual data:
  Request body:
  {
  “order_id”: 2
  }
```

The traditional solutions, as provided above, may not fully eliminate the risk of disruptions for users relying on older API versions. Thus, while traditional methods mitigate some API integration challenges they are not without significant disadvantages. Generative Conversational AI provides an opportunity to overcome the existing disadvantages of traditional methods of interfacing with API gateways.

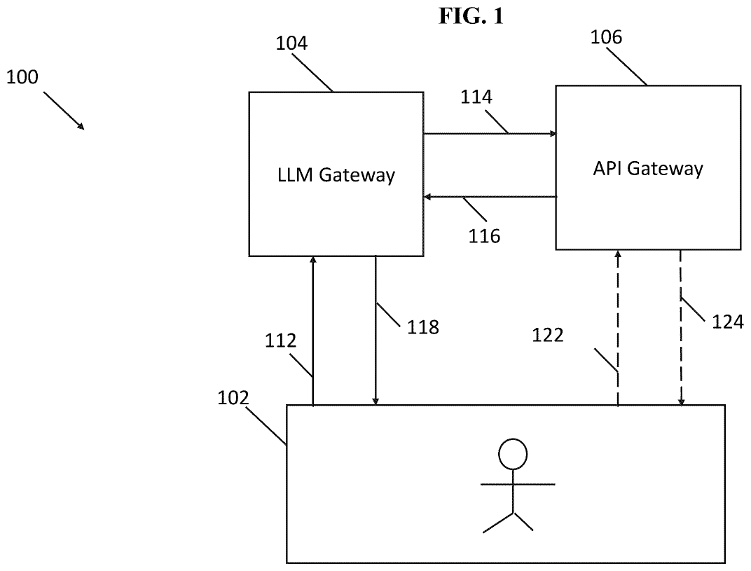

FIG. 1 is a block diagram illustrating a simplified system 100 of interfacing with API gateway using Generative AI application. The system 100 may include an example user 102 interacting with a LLM gateway 104, which in turn, is coupled with an API gateway 106. The LLM gateway 104 may receive an action request prompt 112, in a natural language, from the user 102. The action request prompt 112 may be received as a plain text input. The action request prompt 112 may describe a functional action such as “CREATE”, “DELETE”, and the like, to be performed or executed by the API gateway 106. The functional action may have a number of corresponding functional parameters. Typically, the application programming interface (API) gateway 106 may have a number of operational semantics. The functional action and the functional parameters of the LLM gateway 104 may be agnostic about the operational semantics of the API gateway 106.

As used herein, a platform or system is “agnostic” regarding support of one or more API gateways, if it is able to support and integrate multiple API gateways without being dependent on any single one. API gateway agnostic solutions may offer flexibility by seamlessly integrating with various API gateways, regardless of their providers. This flexibility may allow users to leverage the strengths of various API gateways and choose the most suitable model for their specific tasks and requirements, adapting quickly to new advancements and changes in the available API offerings. Being API gateway agnostic allows the user to avoid lock-in situations with the providers and associated costs. The users may be able to switch between models and providers as needed, ensuring that they may find the most cost-effective solution for their requirements. This flexibility helps reduce operational costs and maximizes return on investment. Further, by choosing an API gateway agnostic solution of the present disclosure, the users may future-proof their API strategy. As new models and technologies emerge, users can adopt and integrate them into their workflow. This adaptability ensures that API capabilities remain at the cutting edge, giving the users a competitive advantage in a rapidly evolving technical field.

Referring back to FIG. 1, the large language model (LLM) gateway 104 may tokenize the natural language request 112 and extract the functional action and the corresponding functional parameters from the action request prompt 112 into a tokenized API query 114. The tokenized API query 114 may map the extracted functional action and the corresponding functional parameters to corresponding API queries that may have corresponding structured data formats. The LLM gateway 104 may send the API queries to the API gateway 106 in the mapped structured data formats, for execution of the API requests received from the user 102.

An example solution implementing the method and system of the present disclosure is provided below. The example solution may be an “e-Commerce Order Processing and Management” system tracking order from payment to delivery. The example solution may include micro services to provide example functionalities such as “Create”, “Retrieve”, “Update”, and “Return” related to an order. A provider of the example solution may describe the purpose of these example functionalities in detail, or use other means to generate a body of text that describes the purpose of these example functionalities. The example solution may be executed by using traditional methods that can train on a source code and create a description in a natural language such as English, using machine learning. Unlike in the traditional methods, the solution providers of the present disclosure may provide API endpoints that may receive user requests in natural language and likewise, users executing the API endpoint responses may receive the responses in natural languages of their choice, instead of structured API data formats. API endpoints examples, in accordance with the methods and systems of the present disclosure, are provided below:

API endpoint: /ecom_eservice/orders/
Parameters:
Description of the Request: <type> (string)

These parameters may be used to specify the type of request being made, such as create, retrieve, update, or return the order.

```
Example POST request to create a new order:
  POST /ecom_eservice/orders/
  Request Body:
  {
  “description”: “Create a new order for customer John Doe with the following items:
  Item 1: T-shirt (size: M, color: blue)
  Item 2: Jeans (size: 32, color: black)”
  }
Example GET request to retrieve an order:
  GET /ecom_eservice/orders/?order_id=123
Example PUT request to update an existing order:
  PUT /ecom_eservice/orders/123
Example Request Body:
  {
  “description”: “Update the order for customer John Doe by adding a new item:
  Item 3: Shoes (size: 9, color: brown)”
  }
Example DELETE request to return an order:
  DELETE /ecom_eservice/orders/123
```

Continuing to refer to FIG. 1, the API gateway 106 may execute the API requests received from the user 102 and the LLM gateway 104 may receive a post-execution API response 116 from the API gateway 106 in the structured data formats. Further, the LLM gateway 104 may render the post-execution API response in an action request response 118 in the same natural language, as input or any other natural language of choice. The LLM gateway 104 may return the action request response 118 to the user 102.

The large language models of the LLM gateway 104 may be trained on an input body of text describing the API queries and the corresponding structured data formats of the API gateway. Further, the large language models of the LLM gateway 104 may be periodically updated based on changes in the structured data formats of the API gateway.

The functions of the system 100 may further include documenting the API queries, the corresponding structured data formats, and the changes in the structured data formats. The functions of the system 100 may also include versioning the large language model, the API queries, the corresponding structured data formats, and the changes in the structured data formats in accordance with predetermined version control rules.

In an example instance, an update to a “CREATE” order API may be needed to ask an example vendor to provide a “Deliver By” date. In the traditional approaches, the API queries need to be furnished in specific, predetermined data format when the API queries are sent. By the method of system of the present disclosure, a new parameter, “Deliver by”, to be provided in a multiple-option natural language “Date” format, may be introduced. An example user may add the details of the intended delivery date in any one of several example natural language forms, such as, by specifying the number of days, or by specifying a specific day, or by specifying an exact date. The API endpoint may be able to interpret and execute the query with required documentation provided at the backend and deliver the orders by the requested date. Example natural language API request prompts from users are provided below:

```
Example Request Body #1:
  {
  “description”: “Create a new order for customer John Doe with the following items and
  deliver them in 5 days:
  Item 1: T-shirt (size: M, color: blue)
  Item 2: Jeans (size: 32, color: black)”
  }
Example Request Body #2:
  {
  “description”: “Create a new order for customer John Doe with the following items and
  deliver them on the 1st day of next month:
  Item 1: T-shirt (size: M, color: blue)
  Item 2: Jeans (size: 32, color: black)”
  }
Example Request Body #3:
  {
  “description”: “Create a new order for customer John Doe with the following items and
  deliver them on the 1st of May:
  Item 1: T-shirt (size: M, color: blue)
  Item 2: Jeans (size: 32, color: black)”
  }
```

Thus, the system and method of the present disclosure may empower organizations to interface with API gateways having their own operational semantics, using LLM gateways that may convert users' natural language request prompts to API queries in their structured data formats. The LLM gateways may also return natural language results after the API processes the requests, ensuring they are relevant and effective across different contexts within the same organization. Referring to FIG. 1 once more and summarizing from a developer's or similar user's perspective (such as user 102 of FIG. 1), the API gateways (such as 106 of FIG. 1) continue to be the end-point references of interest, while the LLM gateways (such as 104 of FIG. 1), if co-located with the API gateways, may provide effective support for interfacing between the developers and the API gateways, as represented by the dotted interaction lines 122 and 124.

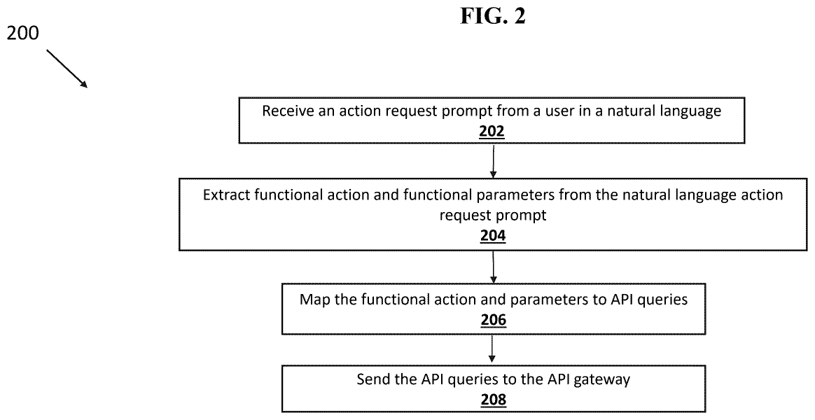

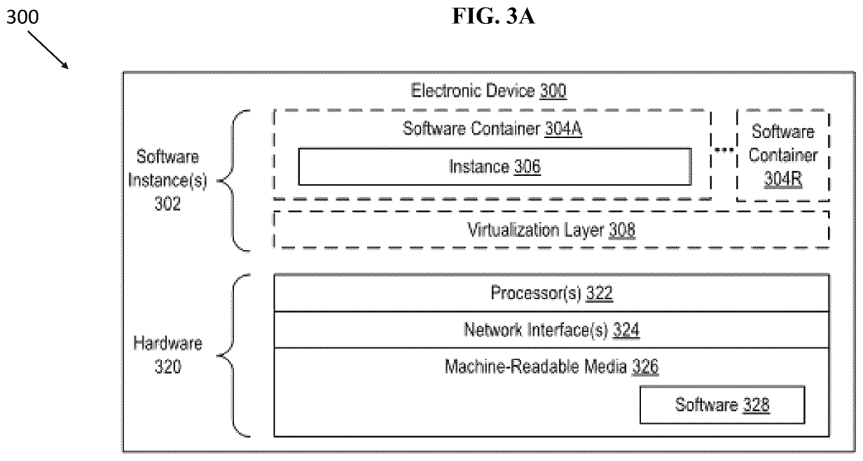

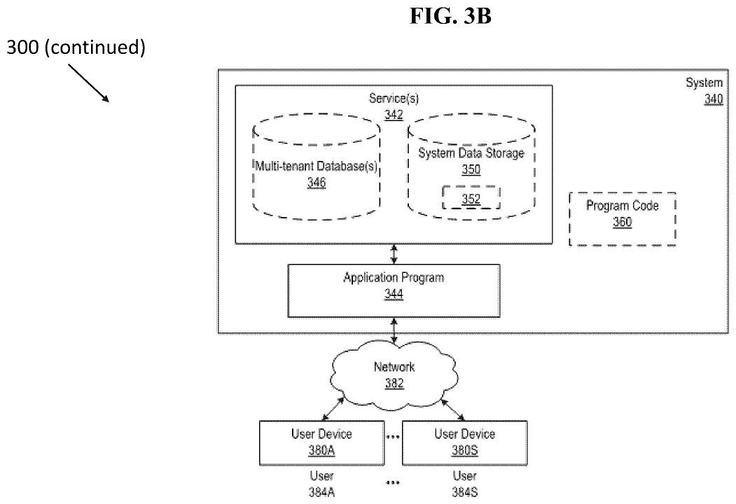

FIG. 2 is a flow diagram illustrating an example method 200 for interfacing with an application programming interface (API) gateway having a number of operational semantics, as disclosed herein. The method 200 may be performed, for example, by a system as shown in FIG. 1 operating in conjunction with the hardware as shown in FIGS. 3A and 3B and/or by software executing on a server or distributed computing platform. Although the steps of method 200 are presented in a particular order, this is only for simplicity.

The computer-implemented method 200 may include, as in step 202, receiving an action request prompt in a first natural language from a user. The action request prompt may be received as a plain text input. The action request prompt may describe a functional action to be performed by the API gateway. The functional action may have a number of corresponding functional parameters and the functional action and the functional parameters may be agnostic about the operational semantics of the API gateway.

At 204, a large language model (LLM) gateway, coupled with the API gateway, may tokenize the natural language request, and further, may extract the functional action and the corresponding functional parameters from the tokenized action request prompt. At 206, the LLM Gateway may map the extracted functional action and the corresponding functional parameters to corresponding API queries. The API queries may have corresponding structured data formats.

At 208, the LLM Gateway may send the API queries to the API gateway in the mapped structured data formats. In an instance, the LLM gateway may receive an API response from the API gateway in the structured data formats, render the API response in an action request response in a second natural language, and further, return the action request response to the user.

Embodiments of the present disclosure describe a method and system for interfacing with APIs, using a large language models (LLM), to translate plain-text natural language requests from users into structured API queries. This approach addresses common challenges in API integration, such as, compatibility issues, documentation and versioning. For example, users may interact with API endpoints using plain text without needing to make changes in API structure formats or version updates. A LLM gateway bridging the users' natural language text requests and the API Gateway may tokenize and process these requests, map them to appropriate API queries, and return responses to the users in natural language. The LLM gateway may be trained on detailed descriptions of the API's functionality and may be periodically updated to reflect any changes. This solution may simplify API usage, reduce the need for extensive documentation, and ensure seamless integration and backward compatibility.

One or more parts of the above implementations may include software. Software is a general term whose meaning can range from part of the code and/or metadata of a single computer program to the entirety of multiple programs. A computer program (also referred to as a program) includes code and optionally data. Code (sometimes referred to as computer program code or program code) includes software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (typically, though not necessarily an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices. The term “consumer” refers to another computer service that is running the reusable software components of the system of FIG. 1.

FIG. 3A is a block diagram illustrating an electronic device 300 according to some example implementations. FIG. 3A includes hardware 320 including a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and server components may be implemented in one or more electronic devices 300. In one implementation: 1) each of the clients is implemented in a separate one of the electronic devices 300 (e.g., in end user devices where the software 328 represents the software to implement clients to interface directly and/or indirectly with server components (e.g., software 328 represents a web browser, a native client, a portal, a command-line interface, and/or an application programming interface (API) based upon protocols such as Simple Object Access Protocol (SOAP), Representational State Transfer (REST), etc.)); 2) server components is implemented in a separate set of one or more of the electronic devices 300 (e.g., a set of one or more server devices where the software 328 represents the software to implement the framework for providing additional security to protected fields in protected views); and 3) in operation, the electronic devices implementing the clients and server components would be communicatively coupled (e.g., by a network) and would establish between them (or through one or more other layers and/or other services) connections for submitting requests to server components and returning responses to the clients. Other configurations of electronic devices may be used in other implementations (e.g., an implementation in which the client and server components are implemented on a single one of electronic device 300).

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine (such as Docker Engine by Docker, Inc. or rkt in Container Linux by Red Hat, Inc.) running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including server components. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

In some implementations, the system 340 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

In some implementations, the system 340 may be an Integrated Development Environment (IDE), such as Visual Studio Code, available from Microsoft Corporation. As is commonly known in systems architecture, integrated development environments (IDEs) typically are designed to maximize programmer productivity by providing tight-knit components with similar user interfaces. IDEs generally present a single program in which all development tasks may be performed. These programs typically provide many features for authoring, modifying, compiling, deploying and debugging software. Software developers may use these programs and features to build their applications, and an example IDE or IDE extension may potentially suggest suitable prompts based on the example LLM Gateway 104 (FIG. 1) or the API gateway 106 (FIG. 1) of the instant disclosure they are interacting with in an application.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Predictive Product Availability for Grocery Delivery; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“application store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. Embodiments disclosed herein may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting

What is claimed is:

1. A computer-implemented method for interfacing with an application programming interface (API) gateway having a plurality of operational semantics, the method comprising:
receiving an action request prompt, in a first natural language, from a user, the action request prompt describing a functional action to be performed by the API gateway, the functional action having a plurality of corresponding functional parameters, the functional action and the functional parameters being agnostic about the operational semantics of the API gateway;
extracting the functional action and the corresponding functional parameters from the action request prompt, by a large language model (LLM) gateway, coupled with the API gateway;
mapping the extracted functional action and the corresponding functional parameters, by the LLM gateway, to corresponding API queries having corresponding structured data formats; and
sending the API queries to the API gateway, by the LLM gateway, in the mapped structured data formats.

2. The method of claim 1 further comprising tokenizing the action request prompt, and extracting the functional action and the corresponding functional parameters from the tokenized action request prompt by the LLM gateway.

3. The method of claim 2 further comprising:
receiving an API response from the API gateway, by the LLM gateway, the API response being in the structured data formats;
rendering the API response, by the LLM gateway, in an action request response in a second natural language; and
returning the action request response to the user.

4. The method of claim 3, wherein the action request prompt is received as a plain text input.

5. The method of claim 4 further comprising training the large language model on a body of text describing the API queries and the corresponding structured data formats of the API gateway.

6. The method of claim 5 further comprising periodically updating the LLM gateway based on changes in the structured data formats of the API gateway.

7. The method of claim 5 further comprising documenting the API queries, the corresponding structured data formats, and the changes in the structured data formats.

8. The method of claim 5 further comprising versioning the large language model, the API queries, the corresponding structured data formats, and the changes in the structured data formats in accordance with predetermined version control rules.

9. The method of claim 5, wherein the first language and the second language are same.

10. A non-transitory machine-readable storage medium that provides instructions that, if executed by a processor, are configurable to cause said processor to perform operations comprising:
receiving an action request prompt in a first natural language from a user, the action request describing a functional action to be performed by the API gateway, the functional action having a plurality of corresponding functional parameters, and the functional action and the functional parameters being agnostic about the operational semantics of the API gateway;
extracting the functional action and the corresponding functional parameters from the action request prompt, by a large language model (LLM) gateway, coupled with the API gateway;
mapping the extracted functional action and the corresponding functional parameters, by the LLM gateway, to corresponding API queries having corresponding structured data formats; and
sending the API queries to the API gateway, by the LLM gateway, in the mapped structured data formats.

11. The non-transitory machine-readable storage medium of claim 10 further comprising tokenizing the action request prompt, and extracting the functional action and the corresponding functional parameters from the tokenized action request prompt by the LLM gateway.

12. The non-transitory machine-readable storage medium of claim 11 further comprising:
receiving an API response from the API gateway, by the LLM gateway, the API response being in the structured data formats;
rendering the API response, by the LLM gateway, in an action request response in a second natural language; and
returning the action request response to the user.

13. The non-transitory machine-readable storage medium of claim 12, wherein the action request prompt is received as a plain text input.

14. The non-transitory machine-readable storage medium of claim 13 further comprising training the large language model on a body of text describing the API queries and the corresponding structured data formats of the API gateway.

15. The non-transitory machine-readable storage medium of claim 14 further comprising periodically updating the LLM gateway based on changes in the structured data formats of the API gateway.

16. The non-transitory machine-readable storage medium of claim 14 further comprising documenting the API queries, the corresponding structured data formats, and the changes in the structured data formats.

17. The non-transitory machine-readable storage medium of claim 14 further comprising versioning the large language model, the API queries, the corresponding structured data formats, and the changes in the structured data formats in accordance with predetermined version control rules.

18. The non-transitory machine-readable storage medium of claim 14, wherein the first language and the second language are same.

19. A system comprising:
a processor;
a cloud-based computing resource digitally connected with the processor;
a non-transitory machine-readable storage medium that provides instructions that, if executed by the processor, are configurable to cause the system to perform operations comprising:
receiving an action request prompt in a first natural language from a user, the action request describing a functional action to be performed by the API gateway, the functional action having a plurality of corresponding functional parameters, and the functional action and the functional parameters being agnostic about the operational semantics of the API gateway;
extracting the functional action and the corresponding functional parameters from the action request prompt, by a large language model (LLM) gateway, coupled with the API gateway;
mapping the extracted functional action and the corresponding functional parameters, by the LLM gateway, to corresponding API queries having corresponding structured data formats; and
sending the API queries to the API gateway, by the LLM gateway, in the mapped structured data formats.

20. The system of claim 19 further comprising tokenizing the action request prompt, and extracting the functional action and the corresponding functional parameters from the tokenized action request prompt by the LLM gateway.

21. The system of claim 20 further comprising:
receiving an API response from the API gateway, by the LLM gateway, the API response being in the structured data formats;
rendering the API response, by the LLM gateway, in an action request response in a second natural language; and
returning the action request response to the user.

22. The system of claim 21, wherein the action request prompt is received as a plain text input.

23. The system of claim 22 further comprising training the large language model on a body of text describing the API queries and the corresponding structured data formats of the API gateway.

24. The system of claim 23 further comprising periodically updating the LLM gateway based on changes in the structured data formats of the API gateway.

25. The system of claim 23 further comprising documenting the API queries, the corresponding structured data formats, and the changes in the structured data formats.

26. The system of claim 23 further comprising versioning the large language model, the API queries, the corresponding structured data formats, and the changes in the structured data formats in accordance with predetermined version control rules.

27. The system of claim 23, wherein the first language and the second language are same.
